(19) United States
(12) Patent Application Publication
(10) Pub. No.: US 2025/0346149 A1
(43) Pub. Date: Nov. 13, 2025

(54) DISPLAY SYSTEM AND VEHICLE

(71) Applicant: TOYOTA JIDOSHA KABUSHIKI KAISHA, Toyota-shi (JP)

(72) Inventors: Tsubasa MIGITA, Sakai-shi (JP); Taro MATSUSHITA, Toyokawa-shi (JP); Yasuhiro KURODA, Toyota-shi (JP); Akio UOTANI, Nagoya-shi (JP); Shinji ICHIKAWA, Nagoya-shi (JP); Shuta ITO, Toyota-shi (JP)

(73) Assignee: TOYOTA JIDOSHA KABUSHIKI KAISHA, Toyota-shi (JP)

(21) Appl. No.: 19/012,090

(22) Filed: Jan. 7, 2025

(30) Foreign Application Priority Data
May 8, 2024 (JP) 2024-075617

(51) Int. Cl. B60L 58/12; B60L 53/80; B60L 58/19

(52) U.S. Cl. CPC B60L 58/12; B60L 53/80; B60L 58/19; B60L 2250/16

(57) ABSTRACT

The display system displays information on the vehicle including the switching circuit capable of switching the series connection/the parallel connection of the plurality of power storage devices. The display system includes a display device. The display device is configured to display an average SOC when a first condition is established, the average SOC indicating an average value of an SOC of each of the power storage devices, and the display device is configured to display a minimum SOC when a second condition is established, the minimum SOC indicating a smallest value among the SOCs of the power storage devices.

### CROSS-REFERENCE TO RELATED APPLICATION

This application claims priority to Japanese Patent Application No. 2024-075617 filed on May 8, 2024, incorporated herein by reference in its entirety.

### BACKGROUND

### 1. Field

The present disclosure relates to a display system and a vehicle.

### 2. Description of Related Art

Japanese Unexamined Patent Application Publication No. 2017-169367 (JP 2017-169367 A) discloses a display system including an estimation unit that estimates a residual amount of a battery module including a plurality of secondary batteries connected in series, and a display unit that displays the estimated remaining amount. The estimation unit specifies a secondary battery having the largest change in voltage, and the estimation unit estimates the residual amount of the battery module based on the specified voltage of the secondary battery.

### SUMMARY

The battery module includes a plurality of power storage devices (secondary batteries) connected in series. However, in a vehicle that includes the battery module, it is difficult to change the voltage of the battery module (power storage unit) in accordance with the circumstances. Therefore, for example, it can be considered to provide a switching circuit in a vehicle that includes the power storage devices, such that the voltage of each of the power storage units of the vehicle can be changed in accordance with the circumstances. The switching circuit is configured to be switchable between a series state in which the power storage devices are connected in series and a parallel state in which the power storage devices are connected in parallel. In the display system described in JP 2017-169367 A, a power storage amount (residual amount) of the battery module estimated by the estimation unit is constantly displayed. When the display system described in JP 2017-169367 A is applied to a vehicle that includes the switching circuit, there is a possibility that the convenience of a user is impaired in accordance with the circumstances.

The present disclosure can provide a display system and a vehicle, in which the vehicle includes a plurality of power storage devices and the display system can notify an appropriate power storage amount to a user in accordance with the circumstances.

According to one aspect of the present disclosure, a display system for a vehicle is provided. The vehicle includes a plurality of power storage devices and a switching circuit. The switching circuit is configured to be switchable between a series state in which the power storage devices are connected in series and a parallel state in which the power storage devices are connected in parallel. The display system includes a display device. The display device is configured to display an average SOC when a first condition is established, the average SOC indicating an average value of an SOC of each of the power storage devices, and the display device is configured to display a minimum SOC when a second condition is established, the minimum SOC indicating a smallest value among the SOCs of the power storage devices.

The power storage devices each function as a power storage unit of the vehicle. SOC means a State Of Charge. SOC indicates a ratio of the present power storage amount with respect to a power storage amount in a fully charged state. The display system can select one of the average SOC and the minimum SOC to be displayed. The average value may be an arithmetic average value or a weighted average value. In the vehicle that includes the switching circuit that is switchable between a series connection and a parallel connection of the power storage devices, it can be considered that there are circumstances where it is better to notify the average SOC to a user and circumstances where it is better to notify the minimum SOC to the user. For this point, the display system can display the average SOC in circumstances where it is better to notify the average SOC to the user, and the display system can display the minimum SOC in circumstances where is better to notify the minimum SOC to the user. The configuration enables an appropriate power storage amount to be notified to the user in accordance with the circumstances, for the vehicle that includes the switching circuit that is switchable between a series connection and a parallel connection of the power storage devices.

According to another aspect of the present disclosure, a vehicle that includes the display system is provided.

According to the present disclosure, a display system and a vehicle can be provided in which the vehicle includes a plurality of power storage devices and the display system can notify an appropriate power storage amount to a user in accordance with the circumstances.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a vehicle to which a display system according to an embodiment of the present disclosure is applied;

FIG. 2 is a diagram illustrating a circuit configuration of each of the vehicle body and the battery pack according to the present embodiment;

FIG. 3 is a diagram illustrating an example of a configuration of a battery replacement system according to the present embodiment;

FIG. 4 is a flowchart showing display control according to the present embodiment;

FIG. 5 is a flow chart showing the detailed process of the travel shown in FIG. 4; and

FIG. 6 is a flowchart showing the details of the processing related to the external charging shown in FIG. 4.

### DETAILED DESCRIPTION OF EMBODIMENTS

An embodiment of the present disclosure will be described in detail with reference to the drawings. The same or corresponding parts in the drawings are designated by the same reference signs and repetitive description will be omitted.

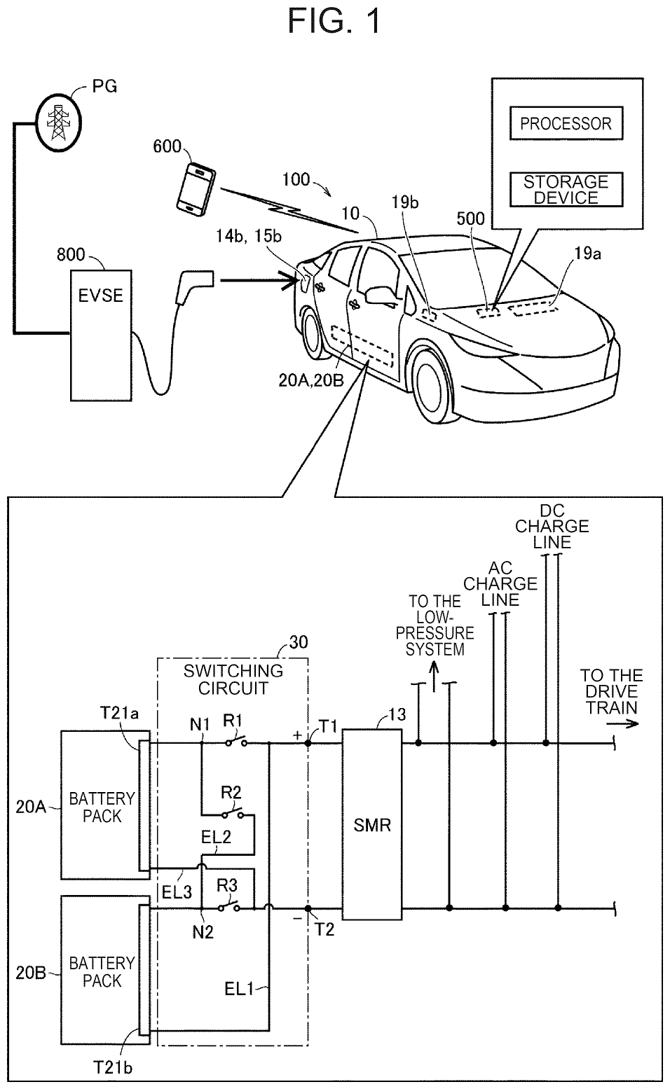

The display system according to this embodiment displays information about a vehicle. FIG. 1 is a diagram illustrating an example of a vehicle to which a display system is applied. Referring to FIG. 1, a vehicle 100 includes a vehicle body 10 and a battery pack 20A, 20B. The vehicle body 10 is a part of the vehicle 100 other than the battery pack 20A, 20B. The vehicles 100 are configured to be able to travel using the electric power stored in the battery pack 20A, 20B. The vehicles 100 are, for example, battery electric vehicle (BEV) without an internal combustion engine. However, the present disclosure is not limited thereto, and the vehicles 100 may be PHEV (plug-in hybrid electric vehicle) equipped with an internal combustion engine or other electrified vehicle (xEV).

The vehicle body 10 includes a switching circuit 30. The switching circuit 30 is configured to be able to switch between a series state in which the battery packs 20A, 20B are connected in series and a parallel state in which the battery packs 20A, 20B are connected in parallel. The switching circuit 30 includes three relays R1, R2, R3. The relay RI is provided in an electric wire EL1 connecting the positive electrode terminal of the battery pack 20A and the positive electrode terminal of the battery pack 20B. The relay R2 is provided in an electric wire EL2 connecting the positive electrode terminal of the battery pack 20A and the negative electrode terminal of the battery pack 20B. The relay R3 is provided in an electric wire EL3 connecting the negative electrode terminal of the battery pack 20A and the negative electrode terminal of the battery pack 20B. The electric wire EL1 and the electric wire EL2 are connected to each other at a node N1. The electric wire EL2 and the electric wire EL3 are connected to each other at a node N2. The voltage of the battery pack 20A, 20B connected to each other is outputted between the terminal T1 (positive electrode terminal) and the terminal T2 (negative electrode terminal) via the switching circuit 30. Each of the terminals T1, T2 is provided in the electric wire EL1, EL3. The relay R1 is located between the terminal Tl and the node N1. The relay R3 is located between the terminal T2 and the node N2. When each of the relays R1, R2, R3 is OFF, ON, OFF, the battery pack 20A, 20B is connected in series (series state). When the relays R1, R2, R3 are ON, OFF, ON, the battery pack 20A, 20B are connected in parallel (parallel state). As a switching relay (relay R1, R2, R3) for switching between a series state and a parallel state, an electromagnetic-type mechanical relay can be adopted. Alternatively, however, a semiconductor relay may be used. The switching circuit 30 may switch between a series drive system (e.g., a drive system of 800 V) and a parallel drive system (e.g., a drive system of 400 V) that drives at a lower voltage than the series drive system. Hereinafter, in the vehicle 100, the battery pack 20A, 20B in the series state and the battery pack 20A, 20B in the parallel state may be referred to as a series state and a parallel state of the vehicle 100, respectively.

The vehicle 100 is configured to perform external charging of the battery pack 20A, 20B (charging by electric power supplied from the outside of the vehicle) while being connected to EVSE 800. EVSE means a vehicle power supply facility (Electric Vehicle Supply Equipment). EVSE 800 is supplied with power from a power system PG. The power system PG is a power grid constructed by a transmission and distribution facility. EVSE 800 may be an AC power supply facility that outputs AC power or a DC power supply facility that outputs DC power.

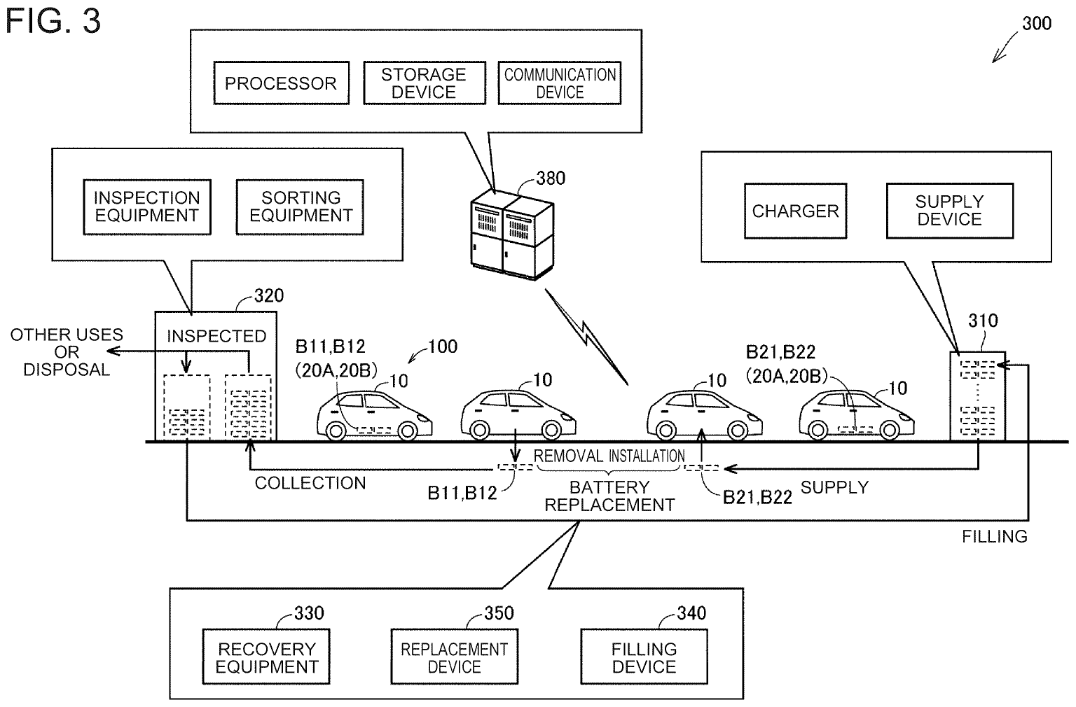

The vehicle body 10 further includes an HMI (Human Machine Interface) 19a and a communication device 19b. The communication device 19b is configured to be capable of wirelessly communicating with each of the mobile terminal 600 and servers 380 (FIG. 3) described later.

HMI 19a includes an inputting device and a displaying device. HMI 19a may include a touch panel display. The input device outputs a signal corresponding to an input from the user to ECU 500. The input device includes a first input unit that receives a system start request and a system stop request, and a second input unit that receives a travel start request and a travel stop request. The input device includes a third input unit that receives a charging start request and a charging stop request, and a fourth input unit that receives a battery replacement request. Each input unit may be a virtual operation unit (for example, a button) displayed on the touch panel display, a physical operation unit, or a smart speaker that receives voice input. Note that the mobile terminal 600 may function as the input device.

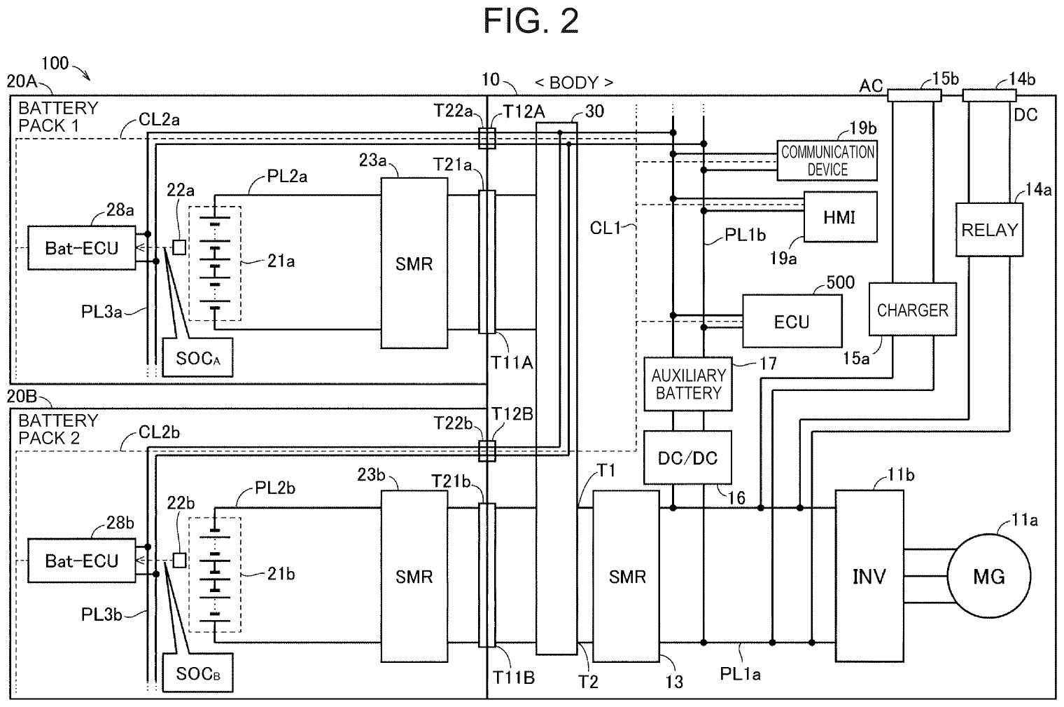

FIG. 2 is a diagram illustrating a circuit configuration of each of the vehicle body 10 and the battery pack 20A, 20B. Referring to FIG. 2, the vehicle body 10 includes a SMR 13 and an ECU 500. The battery pack 20A includes a battery 21a, a BMS 22a, a SMR 23a, an ECU 28a, an electric wire PL2a, PL3a, a communication line CL2a, and a terminal T21a, T22a. The battery-pack 20B includes a battery 21b, a BMS 22b, a SMR 23b, an ECU28b, an electric wire PL2b, PL3b, a communication line CL2b, and a terminal T21b, T22b. “ECU” means an electronic control unit (Electronic Control Unit). “BMS” means Battery Management Systems (Battery Management System). “SMR” means System Main Relay (System Main Relay).

In the vehicle 100, ECU are communicably connected to each other via an in-vehicle network such as a CAN (Controller Area Network), for example. ECU includes a processor and a storage device. The storage device is configured to be able to save the stored information. In addition to the program, various kinds of information are stored in the storage device. In this embodiment, various kinds of control are executed by the processor executing a program stored in the storage device.

In this embodiment, since the battery pack 20A, 20B have the same configuration, they are referred to as “battery pack 20” when they are not distinguished from each other. Similarly, each of the battery 21a, 21b may be referred to as a “battery 21.” Each of BMS 22a, 22b may be referred to as a “BMS 22.” Each of SMR 23a, 23b may be referred to as a “SMR 23.” Each of ECU 28a, 28b may be referred to as an “ECU 28.” Each of the electric wire PL2a, PL2b may be referred to as an “electric wire PL2”. Each of the electric wire PL3a, PL3b may be referred to as an “electric wire PL3”. Each of the communication lines CL2a, CL2b may be referred to as a “communication line CL2”. Each of the terminal T21a, T21b may be referred to as a “terminal T21”. Each of the terminal T22a, T22b may be referred to as a “terminal T22”.

In the battery-pack 20, the electric wire PL2, PL3 functions as a high-voltage power supply line and a low-voltage power supply line, respectively. The battery 21 applies a voltage to the electric wire PL2. The electric wire PL2 is connected to the terminal T21 via a SMR 23. SMR 23 switches the connection/disconnection between the batteries 21 and the terminal T21. Each of the electric wire PL3 (low-voltage power supply line) and the communication line CL2 (broken line in FIG. 2) is connected to the terminal T22. An ECU 28 is connected to each of the electric wire PL3 and the communication line CL2. When the control system of the vehicle 100 is operating normally, SMR 23 remains connected. However, when an error occurs in the battery pack 20, SMR 23 may be shut off and the use of the battery pack 20 (the battery 21) may be prohibited.

ECU 28 corresponds to a control device (Bat-ECU) that monitors the status of the batteries 21 and controls SMR 23. The battery 21 is, for example, a secondary battery such as a lithium ion battery, a nickel metal hydride battery, or a sodium ion battery. The type of the secondary battery may be a liquid secondary battery or an all-solid secondary battery. A plurality of secondary batteries may form a battery pack. BMS 22 detects the condition (current, voltage, temperature, etc.) of the battery 21, and outputs the detected condition to ECU 28. BMS 22 has an SOC (State Of Charge) measuring function, and outputs a measured value of SOC of the batteries 21 to ECU 28. SOC represents, for example, a ratio of the present amount of stored electricity to the amount of stored electricity in a fully charged state, from 0 to 100%. As a method of measuring SOC, for example, a known method such as a current integration method or an OCV (open-circuit voltage) estimation method can be employed.

ECU 28a of the battery pack 20A transmits the measured value of SOC of the battery 21a acquired from BMS 22a (hereinafter, referred to as “SOC_{A}”) to ECU 500 as the information indicating SOC of the battery pack 20A. ECU 28b of the battery pack 20B transmits the measured value of SOC of the battery 21b acquired from BMS 22b (hereinafter, referred to as “SOC_{B}”) to ECU 500 as the information indicating SOC of the battery pack 20B. ECU 500 acquires information indicating the battery status (including SOC_{A}, SOC_{B}) from ECU (control device) of the respective battery packs.

The vehicle body 10 includes a vehicle driving device. Vehicle-driven devices include MG (Motor Generator) 11a and inverters 11b. MG11a functions as a driving motor. The inverter 11b functions as a driving circuit of MG11a. The inverter 11b drives MG11a by using the electric power outputted from the battery pack 20A, 20B to the terminal T1, T2. MG11a converts power to torques and rotates the drive wheels of the vehicles 100. MG11a performs regenerative power generation at the time of deceleration of the vehicles 100, for example, and charges the battery pack 20A, 20B.

The vehicle body 10 includes the above-described charging system for external charging. The charging system includes an AC charger 15a and an AC inlet 15b for charging AC (alternate current) and a DC charging relay 14a and a DC inlet 14b for charging DC (direct current). DC inlet 14b, AC inlet 15b is configured to be connectable to a DC power supply facility and a charge cable of AC power supply facility, respectively. Each of DC inlet 14b and AC inlet 15b has a terminal for detecting connection/disconnection of the charging cable, and outputs to ECU 500 a signal indicating whether or not the charging cable is connected. DC charge-relay 14a is arranged in DC charge line connecting DC inlet 14b and the battery pack 20A, 20B to switch the connection/disconnection of DC charge line. AC charger 15a is disposed in an AC charging line connecting the AC inlet 15b and the battery pack 20A, 20B, and performs power conversion (for example, AC/DC conversion) or switches between connection/disconnection of AC charging line. DC charge-relay 14a and AC charger 15a are controlled by ECU 500.

The vehicle body 10 includes an electric wire PL1a and a PL1b. The electric wire PL1a, PL1b functions as a high voltage power supply line and a low voltage power supply line, respectively. SMR 13 is located between the electric wire PL1a and the terminal T1, T2, and switches between connection/disconnection of both. The electric wire PL1a (high voltage power supply line) is provided with a MG11a, an inverter 11b, DC charge relay 14a, DC inlet 14b, AC charger 15a, and an AC inlet 15b. The vehicle body 10 further includes an auxiliary battery 17 that supplies electric power to auxiliary devices mounted on the vehicle 100. The auxiliary battery 17 applies a voltage lower than the voltage of the battery 21 to the electric wire PL1b. For example, an ECU 500, HMI 19a and a communication device 19b are connected to the electric wire PL1b (low-voltage power supply line). The vehicle body 10 further includes a DC/DC converter 16 that transforms DC power between the electric wire PL1a and the electric wire PL1b. The capacity of the auxiliary battery 17 is smaller than the capacity of the battery 21. When the amount of electric power stored in the auxiliary battery 17 decreases, DC/DC converters 16 step down the DC power from the electric wire PL1a and output it to the auxiliary battery 17.

The vehicle body 10 further includes a terminal T11A, T12A to which the battery pack 20A is detachable, and a terminal T11B, T12B to which the battery pack 20B is detachable. Each of the terminals T11A, T11B is connected to the electric wire PL1a via SMR 13 and the switching circuit 30. Each of the terminal T12A, T12B is connected to an electric wire PL1b (low-voltage power supply line) and a communication line CLI (broken line in FIG. 2) in the vehicle body 10. Each of the terminal T21a, T22a of the battery pack 20A is configured such that the vehicle body 10 is attachable and detachable. Each of the terminal T21b, T22b of the battery-pack 20B is configured to be detachable from the vehicle body 10. The terminals T21a, T22a are respectively connected to the terminals T11A, T12A, and the terminals T21b, T22b are respectively connected to the terminals T11B, T12B. Accordingly, the battery pack 20A,20B are attached to the vehicle body 10, and the vehicle 100 is completed. In the vehicle 100, the communication line CL1 of the vehicle body 10, the communication line CL2a of the battery pack 20A, and the communication line CL2b of the battery pack 20B are connected. These communication lines constitute an in-vehicle network (e.g., a CAN) of the vehicles 100.

The battery pack 20A, 20B mounted on the vehicles 100 can be replaced with another battery pack. FIG. 3 is a diagram illustrating an example of a configuration of a battery replacement system for replacing a battery pack.

Referring to FIG. 3, the battery replacement system 300 is configured to remove a battery pack mounted on the vehicle 100 from the vehicle body 10 and attach another battery pack to the vehicle body 10. Specifically, the battery replacement system 300 includes a first storage device 310, a second storage device 320, a recovery device 330, a filling device 340, a replacement device 350, and a server 380. The first storage device 310 stores a plurality of battery packs to be supplied to the vehicle. The first storage device 310 may include a charger and a supply device in addition to the pack storage unit. The second storage device 320 stores a plurality of battery packs collected from a plurality of vehicles. The second storage device 320 may include an inspection device and a sorting device in addition to the pack storage unit. The server 380 includes a processor, a storage device, and a communication device. The storage device stores the information on the respective battery packs existing in the battery replacement system 300 separately by the identification information (pack ID) of the battery packs.

For example, after the vehicles 100 are parked in a predetermined area in the exchange station, ECU 500 may require replacement of at least one battery pack. In the following, the battery pack 20A, 20B are simultaneously removed from the vehicle 100, and two alternative battery packs are simultaneously attached to the vehicle 100. However, the battery pack 20A, 20B may be replaced one by one in order, or only one may be replaced. Hereinafter, the two battery packs collected from the vehicles 100 will be referred to as “battery pack B11, B12”. The two battery packs attached to the vehicles 100 instead of the battery pack B11, B12 are referred to as “battery pack B21, B22”. Each of the battery pack B11, B12, B21, B22 has the configuration of the battery pack shown in FIG. 2. The battery pack B21, B22 attached to the vehicle body 10 functions as a battery pack 20A, 20B (FIG. 1 and FIG. 2) in the vehicle 100.

In response to a request from the vehicle 100 (ECU 500), the server 380 selects two battery packs that meet the specifications of the vehicle 100 from among the battery packs (stocks) held by the first storage device 310. The selected battery pack is charged by the charger of the first storage device 310 as needed, and the battery pack is in a storage state of a predetermined SOC value or more. Subsequently, the servers 380 control the replacement device 350 so that the battery-pack B11, B12 is removed from the vehicle body 10. Accordingly, the vehicle body 10 and the battery-pack B11, B12 are separated from each other. Subsequently, the server 380 controls the supply device of the first storage device 310 so that the battery-pack B21, B22 having an adequate storage capacity is conveyed (supplied) from the first storage device 310 to the replacement device 350. Subsequently, the servers 380 control the replacement device 350 so that the battery-pack B21 and B22 are attached to the vehicle body 10. Thus, the battery replacement is completed. FIG. 3 illustrates an example in which removal of the battery pack and attachment of the battery pack are performed at different positions. A transport device (not shown) may move the vehicle. However, the removal of the battery pack and the attachment of the battery pack may be performed at the same position. The user may manually replace the battery pack in place of the replacement device 350. For the removed battery pack B11, B12, a reuse process may be performed by the second storage device 320, the recovery device 330, and the filling device 340 (see FIG. 3).

Incidentally, in a vehicle, there is a tendency that information on an amount of electric power storage required by a user changes according to a situation. For example, in a case where there is a possibility that the vehicle is in a power shortage state (a state in which the amount of electric power stored in the electric storage unit is insufficient with respect to the amount of electric power consumed in the vehicle), it is desirable to notify the user of more accurate information on the amount of electric power storage. On the other hand, if the display of the amount of stored electricity changes unnaturally when the vehicle is operating normally, there is a possibility that a sense of discomfort or misunderstanding may be given to the user. The user may misunderstand that the vehicle has failed due to an unnatural transition in the indication of the amount of stored electricity.

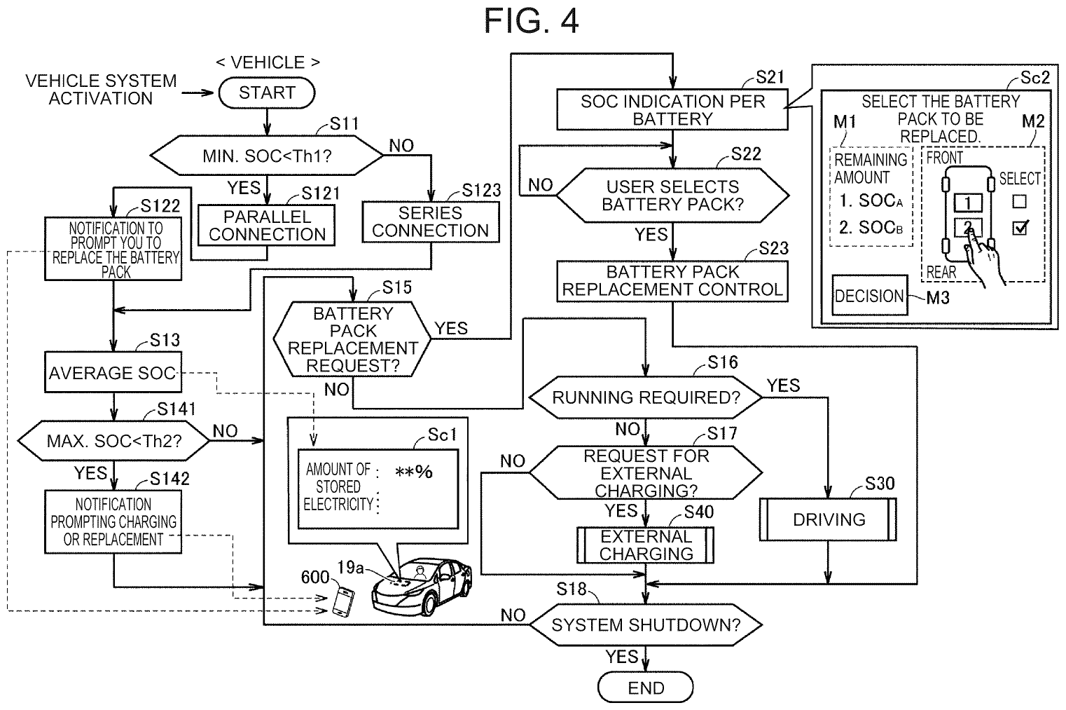

Therefore, the display system according to this embodiment displays an appropriate amount of electricity storage to the user according to the situation according to the processing flow illustrated in FIG. 4 described below. Specifically, when a control system (hereinafter referred to as a “vehicle system”) of the vehicle 100 is stopped (including sleep), HMI 19a may receive any one of a system start request, a travel start request, and a charge start request from a user of the vehicle 100. In this situation, the vehicle-system (including ECU 500) is activated, and ECU 500 starts the process illustrated in FIG. 4. FIG. 4 is a flowchart illustrating display control according to the embodiment. “S” in the flowchart means step.

Referring to FIG. 4, in S11, ECU 500 acquires the present minimum SOC and determines whether or not the minimum SOC is smaller than a predetermined value (hereinafter, referred to as “Th1”). The minimum SOC corresponds to the smallest of SOC of each of the plurality of power storage devices included in the vehicle. In this embodiment, the smaller SOC value of SOC_{A}, SOC_{B} is the minimum SOC.

If the minimum SOC is less than Th1 (YES at S11), ECU 500 controls SMR 23a, 23b and switching circuit 30 so that the battery pack 20A, 20B (and thus the battery 21a, 21b) are in parallel state at S121. Th1 is, for example, a lower limit of a recommended range of the minimum SOC when the vehicles 100 travel when the battery pack 20A, 20B is in series state. The minimum SOC less than Th1 means that it is difficult for the vehicles 100 to travel when the battery pack 20A, 20B is in series state. Vehicle 100 may be able to travel when the battery pack 20A, 20B is in series state, but not when the battery pack 20A,20B is in parallel state. Subsequently, ECU 500 notifies the user terminal of the vehicle 100 to prompt the user terminal to replace the battery pack in S122. The user terminal may be a mobile terminal 600 or an HMI 19a. Upon receiving the notification, the user terminal displays a message prompting the user of the vehicle 100 to replace the battery pack. The user terminal may display the position of the exchange station (battery replacement system 300) on the map. Thereafter, the process proceeds to S13.

On the other hand, if the minimum SOC is greater than or equal to Th1 (NO at S11), ECU 500 controls SMR 23a, 23b and switching circuit 30 such that the battery pack 20A, 20B (and thus the battery 21a, 21b) are in series state at S123. Thereafter, the process proceeds to S13. In S13, ECU 500 obtains the present average SOC and controls the display device so that the average SOC is displayed. The average SOC corresponds to an average of SOC of each of the plurality of power storage devices included in the vehicles. In this embodiment, the arithmetic mean of SOC_{A} and SOC_{B} corresponds to the average SOC. Then, the display device of HMI 19a displays the display Sc1. The display Sc1 displays an average SOC as the amount of electricity stored in the vehicle 100. Note that the display device for displaying the electric storage capacity (SOC) of the vehicles 100 may be a meter panel, a center display, or a head-up display.

In the following S141, ECU 500 obtains the present maximum SOC and determines whether the maximum SOC is less than a predetermined value (hereinafter referred to as “Th2”). The maximum SOC corresponds to the largest of SOC of each of the plurality of power storage devices included in the vehicle. In this embodiment, the larger SOC value of SOC_{A}, SOC_{B} corresponds to the maximum SOC.

When the maximum SOC is smaller than Th2 (YES in S141), ECU 500 notifies the user terminal (see S122) of the external charge or the battery-pack replacement in S142. Upon receiving the notification, the user terminal displays a message prompting the user of the vehicle 100 to externally charge or replace the battery pack. The user terminal may display the location of each of the power supply facility and the exchange station on the map. With the above-described notification, it is easy to avoid electric power shortage of the vehicle 100. Thereafter, the process proceeds to S15. On the other hand, when the maximum SOC is equal to or larger than Th2 (NO in S141), the process skips S142 and proceeds to S15.

In S15, ECU 500 determines whether a battery-replacement request has been received. For example, when HMI 19a is requested to replace the batteries by the user, S15 determines that the batteries are YES. In addition, when ECU 500 receives a battery-replacement request from the server 380, it may be determined as YES by S15. When YES is determined in S15, ECU 500 acquires, by S21, SOC (SOC_{A} and SOC_{B}) of the present battery packs, and controls the display device so that SOC for each battery pack is displayed. The controlled display device may be the same as or different from S13. In this embodiment, a display device (touch panel display) of HMI 19a displays the display Sc2. The display Sc2 includes an information section M1 and an operating section M2, M3. The information section M1 displays SOC (SOC_{A}) of the battery pack 20A and SOC (SOC_{B}) of the battery pack 20B. The operating section M2 indicates each position of the battery pack 20A, 20B in the vehicle body 10, and accepts designation of a battery pack to be replaced. The information section M1 and the operating section M2 display information of the respective battery packs separately by the identification information (1, 2) of the battery packs. After the user selects at least one battery pack by the operating section M2, when the user operates the operation unit M3, information indicating the selected at least one battery pack (hereinafter, referred to as “user-exchanged information”) is transmitted from HMI 19a to ECU 500.

ECU 500 waits for the user's selection while displaying S22 screen Sc2, and when the user's selection ends and the user exchange information is received (YES in S22), executes the above-described battery-pack replacement control (see FIG. 3) in S23. Accordingly, at least one of the battery pack 20A, 20B selected by the user is replaced with another battery pack. When the replacement of the battery is completed, the process proceeds to S18.

As described above, in the vehicle 100, prior to at least one of the plurality of power storage devices being replaced with another power storage device, the display device (HMI 19a) displays SOC of each of the plurality of power storage devices (S21). Therefore, the user of the vehicle 100 can view SOC of each power storage device (for example, a battery pack) and select the power storage device to be replaced from among the plurality of power storage devices.

S18 determines whether ECU 500 has received a shutdown request. If ECU 500 is not requested to shut down (NO at S18), the process returns to S15. ECU 500 receives a battery-replacement request, a running start request, a charge start request, and a system-stop request.

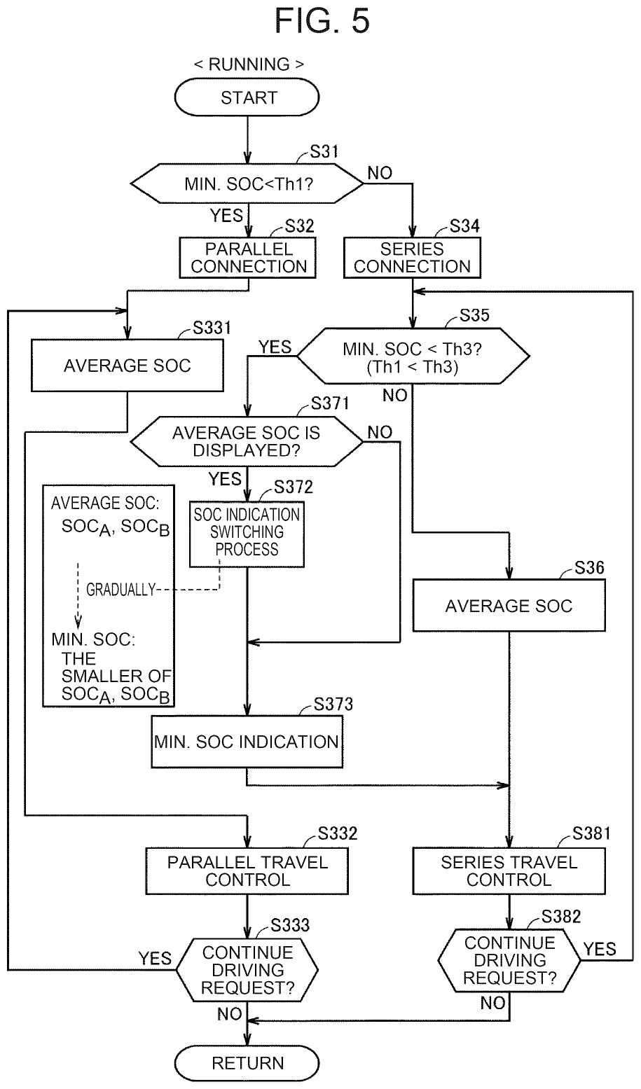

If ECU 500 has not received a battery-replacement request (NO in S15), ECU 500 determines whether or not a travel-start request has been received in S16. For example, when a driving start-request is inputted to HMI 19a from the user, S16 determines that the driving start-request is YES. In addition, when ECU 500 receives the driving starting request from the autonomous driving system, it may be determined as YES by S16. When it is determined that S16 is YES, ECU 500 executes the process illustrated in FIG. 5 in S30. FIG. 5 is a flowchart illustrating a process of traveling of the vehicle 100.

Referring to FIG. 5, in S31, ECU 500 obtains the present minimum SOC and determines whether the minimum SOC is less than Th1. If the minimum SOC is less than Th1 (YES at S31), ECU 500 places the battery pack 20A, 20B (and thus the battery 21a, 21b) in parallel state at S32. Subsequently, ECU 500 causes the display device to display the present average SOC at S331. The process of S31, S32, S331 may be the same as the process of S11, S121, S13 of FIG. 4.

Continuing further, ECU 500 executes, at S332, travel control corresponding to the vehicles 100 in parallel state. Specifically, ECU 500 controls the vehicle driving device such that the vehicle 100 moves (travels) in accordance with the driving instruction using the battery pack 20A, 20B in parallel state as a power source. In the following S333, ECU 500 determines whether or not the driving demand continues. ECU 500 determines that the traveling request is continued if the traveling stopping request is not received. For example, when ECU 500 receives a driving stoppage request from the user or the autonomous driving system, S333 is determined to be NO. If the driving demand continues (YES in S333), ECU 500 continues the driving of the vehicles 100. During traveling, S331, S332 process is repeatedly executed. In S331, the most recent average SOC is displayed. The average SOC is updated each time S331 is processed.

If the minimum SOC is greater than or equal to Th1 (NO at S31), ECU 500 places the battery pack 20A, 20B (and thus the battery 21a, 21b) in series state at S34. Subsequently, ECU 500 obtains the present minimum SOC at S35 and determines whether the minimum SOC is less than Th3. Th3 is an SOC value greater than Th1. Th3 is, for example, a lower limit of a recommended area of the minimum SOC in the traveling vehicles 100. A minimum SOC less than Th3 means that the vehicles 100 may be out of power. If the minimum SOC is greater than or equal to Th3 (NO in S35), ECU 500 causes the display device to display the present average SOC in S36. The processing of S36 may be the same as the processing of S13 of FIG. 4. Subsequently, ECU 500 executes, at S381, travel control corresponding to the vehicles 100 in series state. Specifically, ECU 500 controls the vehicle driving device such that the vehicle 100 moves (travels) in accordance with the driving instruction using the battery pack 20A, 20B in series state as a power source.

In the following S382, ECU 500 determines whether or not the driving demand continues. S382 process may be the same as S333 process. When the driving demand continues (YES in S382), the process returns to S35. Then, when the minimum SOC becomes smaller than Th3 (YES in S35), ECU 500 determines whether or not the aforementioned display device (refer to S13 of FIG. 4) displays the average SOC in S371. In this embodiment, the display device displays either the average SOC or the minimum SOC. For example, when S36 process is executed in the previous process routine, S371 is determined to be YES. Further, when it is determined that S35 is YES in the first processing routine, the processing of S13 of FIG. 4 displays the average SOC, and therefore, it is determined that S371 is YES.

When it is determined that S371 is YES, ECU 500 executes a process for switching the average SOC display by the display device to the minimum SOC display by S372. Specifically, ECU 500 controls the display device such that SOC value between the acquired minimum SOC and the average SOC is displayed while acquiring the latest minimum SOC and the average SOC in a predetermined period (first switching period). ECU 500 may control the display device such that SOC value displayed on the display device gradually or gradually approaches the minimum SOC from the average SOC during the first switching period. When the first switching period ends, the process proceeds to S373.

In S373, ECU 500 controls the display device so that the display device displays the most recent minimum SOC. If S371 determines NO, the process skips S372 and proceeds to S373. The determination of NO in S371 means that the display device is displaying the minimum SOC. S373 process updates the view of the minimum SOC. When S373 process is executed, the process proceeds to S381. While the driving is requested (YES in S382), SOC is updated by S36 or S373 process, and the driving of the vehicles 100 is continued by S381 process.

When it is determined that the vehicle is NO in any of S333, S382, the vehicle 100 ends traveling. Accordingly, the process flow (S30 in FIG. 4) ends, and the process proceeds to S18 in FIG. 4.

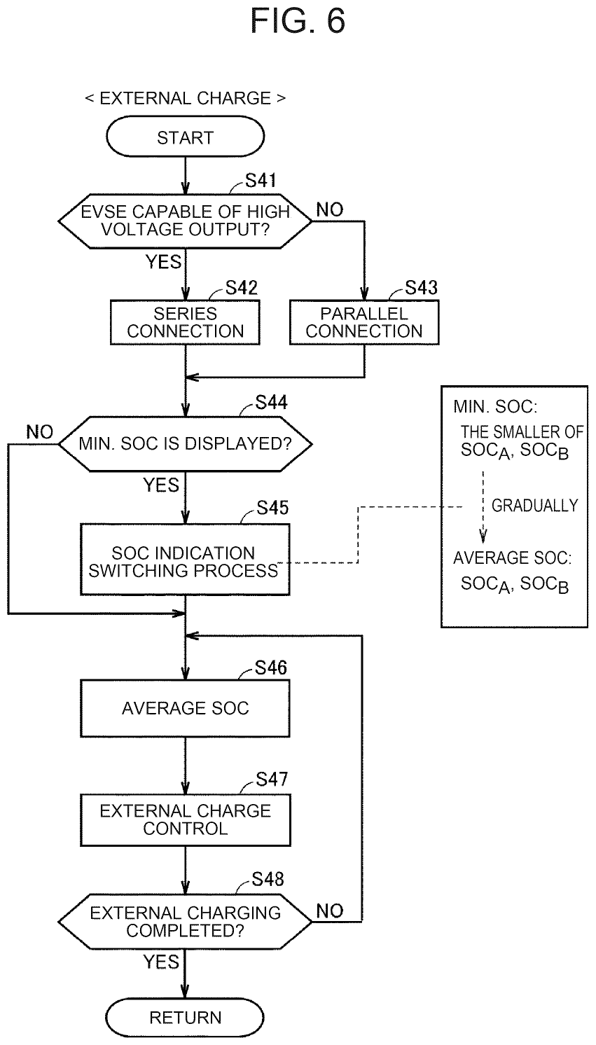

Referring back to FIG. 4, when ECU 500 has not received the travel start request (NO in S16), ECU 500 determines whether or not the charge start request has been received in S17. For example, when the vehicle 100 is connected to a power supply facility (e.g., an EVSE 800) and a charge initiation request is inputted to HMI 19a from the user, S17 is determined to be YES. In addition, when ECU 500 receives a charge-start request from the power supply facility, it may be determined as YES by S17. When it is determined that S17 is YES, ECU 500 executes the process illustrated in FIG. 6 in S40. FIG. 6 is a flowchart illustrating a process related to external charging of the vehicle 100.

Referring to FIG. 6, in a S41, ECU 500 determines whether or not the power supply equipment connected to the vehicles 100 corresponds to charging of the battery pack 20A, 20B in series state (more specifically, charging of the battery 21a, 21b connected in series). ECU 500 may perform a S41 determination based on the power supply facility. For example, if the rated supply voltage of the power supply facility is large enough to charge the battery pack 20A, 20B in series state, S41 is determined to be YES, or S41 is determined to be NO.

If S41 determines YES, ECU 500 places the battery pack 20A, 20B in series state by S42. If S41 determines NO, ECU 500 places the battery pack 20A, 20B in parallel state in S43. When any of the processes of S42, S43 is executed, ECU 500 determines whether or not the above-described display device (refer to S13 of FIG. 4) displays the minimum SOC in S44. For example, when the minimum SOC is displayed by the process of S373 in FIG. 5 in the travel prior to starting the external charge, S44 is determined to be YES.

If S44 determines YES, ECU 500 performs a process for switching the minimum SOC view to the average SOC view in S45. Specifically, ECU 500 controls the display device such that SOC between the acquired minimum SOC and the average SOC value is displayed while acquiring the latest minimum SOC and the average SOC in a predetermined period (second switching period). ECU 500 may control the display device such that SOC value displayed on the display device gradually or gradually approaches the average SOC from the minimum SOC during the second switching period. When the second switching period ends, the process proceeds to S46.

In S46, ECU 500 controls the display device so that the display device displays the most recent average SOC. If S44 determines NO, the process skips S45 and proceeds to S46. The determination of NO in S44 means that the display device is displaying the average SOC. S46 process updates the representation of the average SOC.

In the following S47, ECU 500 performs external charge control while communicating with the power supply so that the battery pack 20A, 20B are charged by the power supplied from the power supply. In the following S48, ECU 500 determines whether or not the external charge has ended. For example, when the maximum SOC becomes equal to or greater than the predetermined value, S48 determines that YES is satisfied. Also, when a charge stopping request is inputted to HMI 19a from the user, it is determined that the charge stopping request is YES in S48. While the external charge has not been completed (NO in S48), S48 process is repeated from S46. As a result, the indication of the average SOC is updated, and the external charge is continued.

When the external charge is completed (YES in S48), the process flow (S40 in FIG. 4) ends, and the process proceeds to S18 in FIG. 4. Referring back to FIG. 4, for example, when a system-stop-request is inputted to HMI 19a from the user, S18 determines that the system-stop-request is YES. When ECU 500 receives a system-stop request from an external device, it may be determined as YES by S18. When it is determined that S18 is YES, ECU 500 performs a predetermined shutdown process, and then the vehicle-system is stopped, and the process illustrated in FIG. 4 ends.

As described above, the method for displaying the amount of stored electricity according to the present embodiment includes the processes illustrated in FIGS. 4 to 6. These processes are executed by ECU 500. ECU 500 is a control device that controls the display device (HMI 19a), and controls the display device such that the display device displays the average SOC when the first condition is satisfied and the display device displays the minimum SOC when the second condition is satisfied. Note that the display device for displaying the electric storage capacity (SOC) of the vehicle 100 is not limited to the display device mounted on the vehicle 100, and may be the mobile terminal 600.

The average SOC continuously changes in accordance with an increase or decrease in the amount of electric power stored in the electric storage unit of the vehicle. Therefore, when the display device continuously displays the average SOC that changes from moment to moment, the display of the average SOC tends to change naturally. On the other hand, in a case where a plurality of power storage devices are in a series state in a vehicle, if there is a variation in the amount of power storage between the power storage devices, there is a possibility that any one of the power storage devices will be in an over-discharge state before the other power storage devices. In order to suppress over-discharge of the power storage unit in vehicles in which a plurality of power storage devices is in series state, it is required that the minimum SOC be sufficiently higher. Therefore, when the plurality of power storage devices is in series state, it can be said that the minimum SOC more accurately represents the power storage capacity of the vehicles than the average SOC.

In this regard, ECU 500 according to the above-described embodiment determines that the first condition is satisfied when the battery pack 20A, 20B is in parallel state. When the battery pack 20A, 20B is in parallel state, the average SOC is displayed (S13 in FIG. 4, S331 in FIG. 5, S46 in FIG. 5). In the vehicle 100 in parallel state, it is considered that the average SOC represents the amount of electricity stored in the vehicle 100 with enough accuracy for the user. In addition, as described above, since the average SOC display tends to change naturally, it is easy to continuously display the electric storage amounts of the vehicles 100 that change from moment to moment.

When the battery pack 20A, 20B is in series state, ECU 500 uses SOC of each of the battery packs 20A, 20B to determine whether the second condition is satisfied. Thus, when the amount of electric power stored in the vehicle 100 is sufficiently large, the average SOC is displayed with priority given to the transition of the natural display (S36 in FIG. 5), and when the amount of electric power stored in the vehicle 100 is small, the minimum SOC can be displayed with priority given to the display accuracy (S373 in FIG. 5). Specifically, ECU 500 determines that the first condition is satisfied when the battery pack 20A, 20B is in series state and the minimum SOC is larger than the predetermined value (Th3), and causes the display device to display the average SOC (S36 in FIG. 5). When the minimum SOC is sufficiently high in the vehicle 100 in the series state, it is considered that the vehicle 100 is unlikely to be in the depleted state. In such cases, since the display device displays the average SOC, the display of SOC tends to change in accordance with the increase or decrease of the electric storage capacity of the vehicles 100. In addition, in ECU 500, the minimum SOC of the battery pack 20A, 20B in series state may be smaller than a predetermined value (Th3) while the average SOC is displayed. In this case, SOC value between the minimum SOC and the average SOC is displayed on the display device in the first switching period (S372 of FIG. 5). Then, ECU 500 determines that the second condition is satisfied when the display in the first switching period is completed, and causes the display device to display the minimum SOC (S373 in FIG. 5). In the vehicle 100 in the series state, for example, when the minimum SOC becomes low to some extent that the possibility that the vehicle 100 is in the depleted state is obtained, ECU 500 causes the display device to display the minimum SOC in preference to the display accuracy. As a result, the user can easily increase the amount of electric power stored in the vehicle 100 at an appropriate timing (for example, before the vehicle 100 is in a power-depleted state). In addition, SOC value displayed on the display device is switched from the average SOC to the minimum SOC value via SOC displayed in the first switching period, which makes it difficult for the user to feel uncomfortable or misunderstand.

ECU 500 causes the display device to display SOC value between the minimum SOC and the average SOC during the second switching period when the battery pack 20A, 20B is charged by the electric power supplied from the outside of the vehicle during the display of the minimum SOC (S45 of FIG. 6). Then, ECU 500 determines that the first condition is satisfied when the display in the second switching period is completed, and causes the display device to display the average SOC (S46 in FIG. 6). When the display device displays the average SOC during the external charge, SOC display tends to change in accordance with an increase in the electric storage capacity of the vehicle 100. In addition, SOC value displayed on the display device changes from the minimum SOC to the average SOC after passing through SOC value displayed in the second switching period, thereby making it difficult for the user to feel uncomfortable or misunderstand.

The functions of the above-described ECU 500 may be realized only by hardware (e.g., electronic circuitry) or may be realized using software. The functions of ECU 500 may be divided into a plurality of units. ECU 500 functions may be realized by a plurality of processors mounted on separate units and a plurality of storage devices mounted on separate units.

The configuration of the vehicle is not limited to the above-described configuration (see FIG. 2). For example, one of SMR 13, 23 may be omitted. The vehicle may include three or more power storage devices (e.g., a detachable battery pack). In a vehicle including three or more power storage devices, the control device (ECU) may determine, in S141 of FIG. 4, whether the second minimum SOC among SOC of each of the three or more power storage devices included in the vehicle is smaller than a predetermined value.

The vehicle is not limited to a passenger car, and may be a bus or a truck. The inlet may be provided on any of the front, rear, left, right, upper and lower surfaces of the vehicle body. The vehicle may be configured to be contactless chargeable. The vehicle may comprise a solar panel. The vehicle may be configured to be capable of autonomous driving, or may have a flight function. The vehicle may be configured to be able to travel unmanned.

The embodiment disclosed herein shall be construed as exemplary and not restrictive in all respects. The scope of the present disclosure is shown by the claims rather than by the above description of the embodiments, and is intended to include all modifications within the meaning and scope equivalent to those of the claims.

What is claimed is:

1. A display system of a vehicle, wherein
the vehicle includes
a plurality of power storage devices, and
a switching circuit configured to be switchable between a series state in which the power storage devices are connected in series and a parallel state in which the power storage devices are connected in parallel,
the display system includes a display device, and
the display device is configured to display an average SOC when a first condition is established, the average SOC indicating an average value of an SOC of each of the power storage devices, and the display device is configured to display a minimum SOC when a second condition is established, the minimum SOC indicating a smallest value among the SOCs of the power storage devices.

2. The display system according to claim 1,
wherein the display system further includes a control device that controls the display device,
wherein the control device determines that the first condition is established when the power storage devices are in the parallel state, and
wherein the control device determines whether the second condition is established by using the SOC of each of the power storage devices when the power storage devices are in the series state.

3. The display system according to claim 2,
wherein the control device determines that the first condition is established when the power storage devices are in the series state and the minimum SOC is larger than a predetermined value, and
wherein when the minimum SOC becomes smaller than the predetermined value during a display of the average SOC for the power storage devices in the series state, the control device causes the display device to display an SOC value between the minimum SOC and the average SOC in a first switching period, and the control device determines that the second condition is established when a display in the first switching period is finished.

4. The display system according to claim 3, wherein when the power storage devices are charged by power supplied from outside of the vehicle during a display of the minimum SOC, the control device causes the display device to display an SOC value between the minimum SOC and the average SOC in a second switching period, and the control device determines that the first condition is established when a display in the second switching period is finished.

5. The display system according to claim 1,
wherein each of the power storage devices is configured to be attachable and detachable with respect to the vehicle, and
wherein the display device is configured to display an SOC of each of the power storage devices before at least one of the power storage devices is replaced with another one of the power storage devices.

6. A vehicle comprising:
a plurality of power storage devices;
a switching circuit configured to be switchable between a series state in which the power storage devices are connected in series and a parallel state in which the power storage devices are connected in parallel;
a display device; and
a control device that controls the switching circuit and the display device, wherein
the control device is configured to cause the display device to display an average SOC when a first condition is established, the average SOC indicating an average value of an SOC of each of the power storage devices, and the control device is configured to cause the display device to display a minimum SOC when a second condition is established, the minimum SOC indicating a smallest value among the SOCs of the power storage devices, and
the control device is configured to determine whether each of the power storage devices is in the series state or the parallel state based on the minimum SOC.
